(19) United States
(12) Patent Application Publication
(10) Pub. No.: US 2025/0218148 A1
(43) Pub. Date: Jul. 3, 2025

(54) DATA PROCESSING METHOD WITH DEVICE, AND A VEDIO PROCESSING METHOD WITH DEVICE

(71) Applicant: Smarter Silicon (Shanghai) Technologies Co., Ltd., Shanghai (CN)

(72) Inventor: Terry LIU, Shanghai (CN)

(21) Appl. No.: 19/000,665

(22) Filed: Dec. 23, 2024

(30) Foreign Application Priority Data
Dec. 28, 2023 (CN) 202311845713.3

(51) Int. Cl. G06V 10/26; G06V 10/75; G06V 10/82

(52) U.S. Cl. CPC G06V 10/26; G06V 10/759; G06V 10/82

(57) ABSTRACT

A data processing method includes inputting first blocks from a plurality of blocks of a divided to-be-processed image into an image processing model, to obtain block processing results of the first blocks, and performing splicing processing on the block processing results of the first blocks and block processing results of second blocks of the processed image, to obtain an image processing result of the to-be-processed image. The first blocks are blocks of the to-be-processed image, which satisfy a processing condition. The processed image and the to-be-processed image are divided in a same division method. The second blocks are blocks of the to-be-processed image which do not satisfy the processing condition, compared to the processed image.

### CROSS-REFERENCE TO RELATED APPLICATION

The present disclosure claims priority to Chinese Patent Application No. 202311845713.3, filed on Dec. 28, 2023, and the entire content of which is incorporated herein by reference.

### TECHNICAL FIELD

The present disclosure relates to the field of image processing, specifically to a data processing method and device, and a video processing method and device.

### BACKGROUND

Artificial Intelligence (AI) models are widely utilized in image processing tasks, such as target recognition performed on images and videos. When processing consecutive video frames, AI models typically need to load and process the entire image frame for each frame. However, there is a significant amount of redundant data between successive frames of images, and conventional techniques require the AI model to repeatedly process the inter-frame redundant data for each frame and the previous frame. This approach consumes substantial bandwidth, and leads to inefficiencies in resource utilization.

### SUMMARY

One aspect of the present disclosure provides a data processing method. The data processing method includes a data processing method includes inputting first blocks from a plurality of blocks of a divided to-be-processed image into an image processing model, to obtain block processing results of the first blocks, and performing splicing processing on the block processing results of the first blocks and block processing results of second blocks of the processed image, to obtain an image processing result of the to-be-processed image. The first blocks are blocks of the to-be-processed image, which satisfy a processing condition. The processed image and the to-be-processed image are divided in the same division method. The second blocks are blocks of the to-be-processed image which do not satisfy the processing condition, compared to the processed image.

Another aspect of the present disclosure provides a data processing device, including a model processing module and a block processing module. The model processing module is configured to input first blocks from a plurality of blocks of a divided to-be-processed image into an image processing model, to obtain block processing results of the first blocks. The first blocks are the blocks of the to-be-processed image, which satisfy a processing condition. A processed image and the to-be-processed image are divided in a same division method. The block processing module is configured to perform splicing processing on the block processing results of the first blocks and block processing results of second blocks of the processed image, to obtain an image processing result of the to-be-processed image. Second blocks are blocks of the to-be-processed image which do not satisfy the processing condition, compared to the processed image.

The third aspect of the present disclosure provides a video processing method. The video processing method includes inputting first blocks from a current frame into an image processing model, to obtain block processing results of the first blocks, and performing splicing processing on the block processing results of the first blocks from the current frame and block processing results of second blocks from a previous frame, to obtain an image processing result of the current frame. The first blocks are blocks of the current frame, which satisfy a processing condition, and all frames are divided into a plurality of blocks according to a predefined division method. The second blocks are blocks of the current frame which do not satisfy the processing condition, compared to the previous frame.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a diagram of the of an AI model processing flow in related technology;

FIG. 2 is a diagram of an input image for the AI model provided in an embodiment of the present disclosure;

FIG. 3 is a diagram of another input image for the AI model provided in an embodiment of the present disclosure;

FIG. 4 is a flowchart of the data processing method provided in the present disclosure;

FIG. 5 is a diagram of the image division approach provided in an embodiment of the present disclosure;

FIG. 6 is a flowchart of the image division approach provided in an embodiment of the present disclosure;

FIG. 7 is a diagram of the interaction flow for data processing provided in an embodiment of the present disclosure;

FIG. 8 is a diagram of the data processing process provided in an embodiment of the present disclosure;

FIG. 9 is a structural diagram of the data processing device provided in an embodiment of the present disclosure;

FIG. 10 is a flowchart of the video processing method provided in the present disclosure;

FIG. 11 is a structural diagram of the video processing device provided in an embodiment of the present disclosure;

FIG. 12 is diagram of the electronic device provided in the present disclosure;

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

In the following description, references to “some embodiments” describe a subset of all possible embodiments. It is understood that “some embodiments” can represent the same or different subsets of all possible embodiments and may be combined with each other without conflict.

In the following description, the terms “first,” “second,” and “third” are used merely to distinguish similar objects and do not indicate a specific order for these objects. It is understood that “first,” “second,” and “third” can interchange their specific order or sequence, where allowed, to enable the embodiments of the present disclosure described herein to be implemented in sequences other than those illustrated or described here.

Unless otherwise defined, all technical and scientific terms used herein have the same meaning as commonly understood by those skilled in the art to which the present disclosure belongs. The terms used in this document are solely for the purpose of describing the embodiments of the present disclosure and are not intended to limit the scope of the present disclosure.

To facilitate understanding of this solution, firstly the background of the embodiments of the present disclosure will be explained before describing the embodiments.

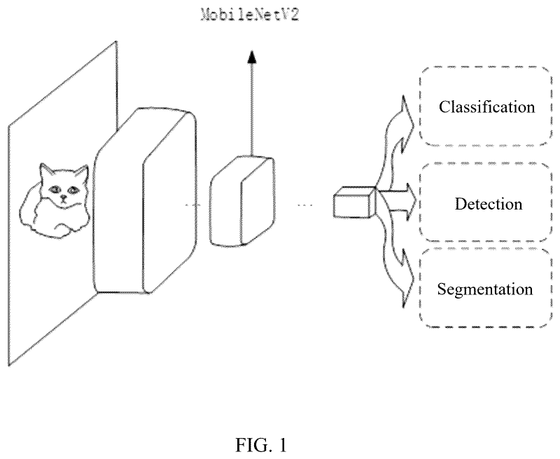

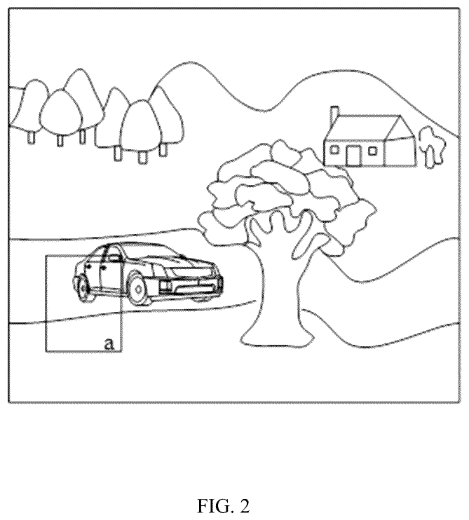

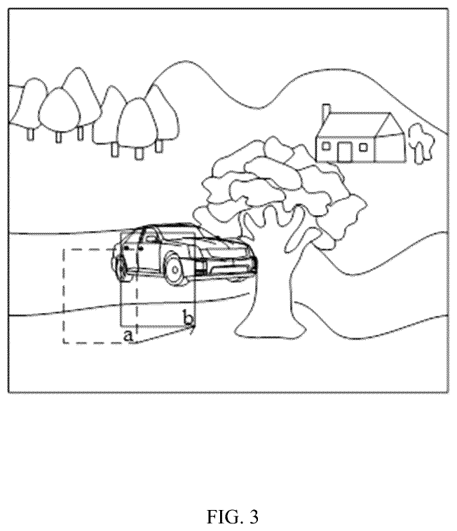

The AI model is an algorithmic model whose algorithms typically need to be compiled into processing instructions before being executed by a Neural-Network Processing Unit (NPU), and then run the AI model. As shown in FIG. 1, the input to the AI model is a full-frame image, and performs inference on this image. For instance, the full-frame image can be used for applications such as classification, detection, and segmentation. In this case, the algorithms of the AI model may include MobileNet_V2, UNet, Real-ESRGAN, and Restormer, etc. When processing various images, the AI model may encounter the situation where the differences between the images can be very small, especially when the images originate from the same environmental background. For example, when the images processed by the AI model are from a video stream, the background between two consecutive frames, or even between two frames separated by multiple frames, typically remains identical. Consequently, the amount of varying data is highly limited. As shown in FIG. 2, the AI model first processes a full-frame image, and FIG. 3 illustrates a subsequent full-frame image processed after processing the full-frame image in FIG. 2. It can be observed that the primary difference between FIG. 2 and FIG. 3 is just the movement of a car. This corresponds to the block a in FIG. 2 shifting to block b in FIG. 3. The elements such as the distant mountains, houses, trees, and roads remain identical. In related technologies, the full-frame image is directly used as the input data for the AI model, either from an Image Signal Processor (ISP) or memory, and then fed into the NPU via the bus. The NPU invokes the compiled model instructions to execute the AI model. Taking processing of 1080p images as an example, the input data size for a full-frame image is 1920×1080×3=5 MB. At a frame rate of 20 frames per second, the total bandwidth required for both input and output data is 2×20×5=200 GB/s. This demonstrates that the AI model consumes substantial bandwidth to process the redundant data between images, which leads to repetitive computations of the same data by processing units such as the NPU. This repetitive computation results in wasted computational power.

Based on the above illustration, some related technologies propose a method to just process data changes between images through an online real-time compilation process. In this method, each time an image is processed, a Software Development Kit (SDK) can be used to generate new code for processing the changed data, and then then the code shall be recompiled. Taking the smallest model in the AI benchmark, which is MobileNet_V2, as an example, its offline compilation time on a server can be on the level of tens of seconds. Even omitting most of the optimization steps, it is still very difficult to complete multiple times of compilations within one second. Therefore, online recompilation requires significant computational resources and consumes substantial bandwidth.

The present disclosure provides a data processing method and device, and a video processing method and device. The methods and devices enable the AI model to process only the changed portions of blocks, which reduces bandwidth consumption. The following description illustrates an exemplary application of the electronic device provided in an embodiment of the present disclosure. The electronic device includes a data processor, and can be implemented as any device with data processing capabilities, such as a server, laptop, tablet, desktop, smart TV, set-top box, and mobile device (e.g., mobile phone, portable video player, personal digital assistant, dedicated messaging device, portable gaming device), and so on.

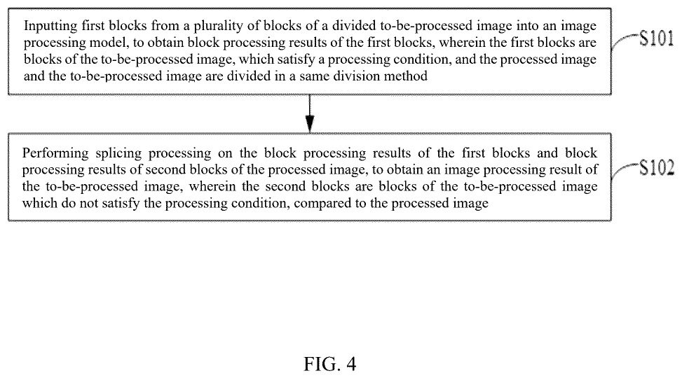

The present disclosure provides an optional data processing method flow, as shown in FIG. 4. The method may include the steps from S101 to S102.

At S101, inputting the first blocks from the multiple divided blocks of the to-be-processed image into an image processing model, to obtain block processing results of the first blocks. The first blocks are the blocks of the to-be-processed image, which satisfy a processing condition, compared to the processed image. The division method of the processed image is the same as that of the to-be-processed image.

In some embodiments of the present disclosure, the processed image refers to the image that has been processed by the image processing model, while the to-be-processed image to refers to the image that requires processing by the image processing model but has not yet been processed. Both the processed image and the to-be-processed image are divided into multiple blocks according to a predefined division approach. The multiple blocks of the unprocessed correspond one-to-one with the multiple blocks of the processed image. The to-be-processed image can be in a predefined image format, which can be configured as needed, and shall not be limited in the embodiments of the present disclosure.

In the embodiment of the present disclosure, the first blocks of the to-be-processed image are the blocks that are needed to be processed by the image model. Different to the first blocks among the multiple blocks of the to-be-processed image, the second blocks are the blocks that are not required to be processed by the image model. In this case, the electronic device can compare each block of the to-be-processed image with the corresponding block of the processed image, to determine that the first blocks are the blocks, which satisfy a processing condition, and the second blocks are the blocks, which do not satisfy the processing condition.

In some embodiments of the present disclosure, when comparing the to-be-processed image with the processed image, the blocks with image differences greater than a difference threshold are determined as the first blocks. The blocks with image differences less than or equal to the difference threshold are determined as the second blocks. In this case, the electronic device can treat blocks with minimal differences as identical blocks, which do not require repeated processing by the image processing model. The electronic device treats the first blocks of the to-be-processed image, which have significant differences compared to the corresponding blocks of the processed image, as different blocks that require processing by the image processing model, to obtain the processing results for these first blocks. The difference threshold can be configured as needed and shall not be limited in the embodiment of the present disclosure.

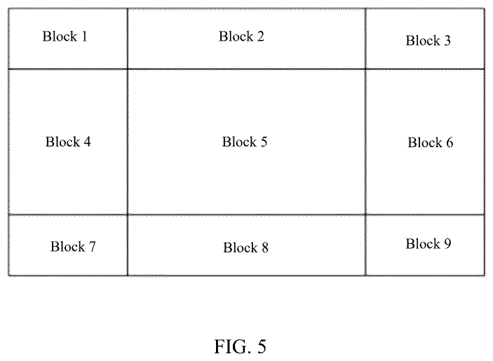

In this case, the multiple blocks obtained by the predefined division approach can either be of the same size or of different sizes. In some embodiments of the present disclosure, the central position of the image has the highest level of attention and a higher likelihood of data changes. Therefore, the central block of the image can be larger than the other blocks. As shown in FIG. 5, the image can be divided into 9 blocks, which is denoted as blocks 1-9 and the central block 5 is the largest. The division approach can be configured as needed and shall not be limited in the embodiment of the present disclosure.

In some embodiments of the present disclosure, when the predefined division approach is uniform division, the number of blocks obtained is positively correlated with the resolution of the image. The higher the resolution of the to-be-processed image and the processed image, the greater the number of blocks can be. In this way, the data volume of each block can remain stable, and the inference time of the image processing model for blocks of different resolutions can be approximately consistent, which improves the processing efficiency of the image processing model.

In some embodiments of the present disclosure, the processed image and the to-be-processed image are consecutive video frames. When the predefined division approach is uniform division, the number of blocks obtained is negatively correlated with the image change rate. The higher the image change rate between the processed image and the to-be-processed image, the smaller the number of blocks can be. In other words, the larger the size of each block, the lower the probability of missing regions with changes during processing, which improves fault tolerance. In this case, the image change rate characterizes the speed of change in image differences between frames over time.

For example, in a soccer match video, where players move quickly and the image change rate is high, the image can be divided into 6 blocks. In contrast, in a Go match video, where the primary changes are hand movements and the placement of pieces on the board, and the piece layout changes slowly, the image change rate is low, and the image can be divided into 4 blocks.

At S102, performing splicing of the block processing results of the first blocks with the block processing results of the second blocks from the processed image to obtain the image processing result for the to-be-processed image. The second blocks are the blocks of the to-be-processed image which do not satisfy the processing condition, compared to the processed image.

In the embodiment of the present disclosure, after obtaining the block processing results of the first blocks, the electronic device can splice these results with the block processing results of the second blocks of the processed image to generate the image processing result for the to-be-processed image. In this case, the image processing result of the to-be-processed image includes the block processing results of both the first blocks and the second blocks. Specifically, the corresponding block processing results of the second blocks from the processed image can be directly used as the block processing results of the second blocks of the to-be-processed image.

For example, in a soccer match video, a frame is evenly divided into 6 blocks, where block 4 of the to-be-processed image is the first block, and blocks 1-3 and 5-6 are the second blocks. The electronic device can input block 4 into the image processing model to obtain the block processing result of block 4. Then, by splicing it with the block processing results of blocks 1-3 and 5-6 from the processed image, the image processing result for the to-be-processed image can be obtained.

It is understandable that, as the image is divided into multiple blocks, the image processing model can process only the first blocks of the to-be-processed image to obtain the processing results of the first blocks, and then splice these results with the processing results of the second blocks of the processed image, to obtain the processing result of the to-be-processed image. This method skips the processing of the second blocks of the to-be-processed image, which reduces the computational load of the image processing model on the second blocks and also saves the bandwidth.

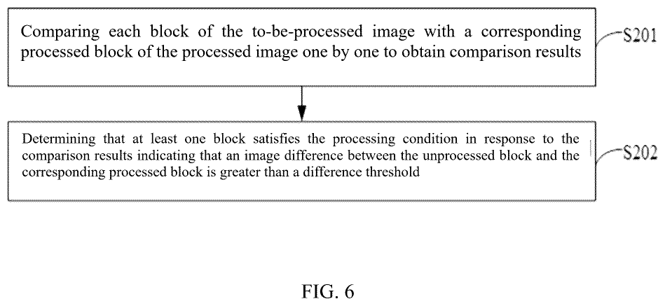

In some embodiments of the present disclosure, the step S101, which is inputting first blocks from multiple blocks of a divided to-be-processed image into an image processing model, to obtain block processing results of the first blocks, may further includes steps S201 and S202, as shown in FIG. 6.

At S201, comparing each block of the to-be-processed image with the corresponding block in the processed image one by one to obtain comparison results.

In the embodiment of the present disclosure, the electronic device can compare each block of the to-be-processed image with the corresponding block in the processed image to obtain comparison results. The comparison results include the comparison outcome for each block. In this case, the comparison results indicate whether the image difference is greater than or less than the difference threshold.

In the embodiment of the present disclosure, block comparison can be performed by comparing the pixel information of each pixel in the block, or by comparing the hash values of the blocks. This can be configured as needed, and shall not be limited in the embodiments of the present disclosure. Note that the hash value is determined based on the overall pixel information of the block, and there is a one-to-one mapping between the hash value and the overall pixel information of the block. The smaller the block size, the smaller the data volume for calculating the hash value, and the higher the efficiency of block comparison.

At S202, determining that at least one block satisfies the processing condition, if the comparison results indicate that the image difference between the at least one block in the to-be-processed image and the corresponding block in the processed image is greater than a difference threshold.

In the embodiment of the present disclosure, after determining the comparison results, the electronic device can determine the first blocks, which are the blocks from the processed image that satisfy the processing condition, based on the comparison results. The first blocks are at least one block in the to-be-processed image whose image difference with the corresponding block in the processed image is greater than the difference threshold.

In some embodiments of the present disclosure, image comparison can involve comparing the pixel information of each pixel within a block. In this case, the image difference can be represented as the proportion of differing pixel information, which is the number of pixels with differing information as a ratio of the total number of pixels in the block. The difference threshold can be set as a proportional threshold. The electronic device can determine the blocks as first blocks, as long as the proportion of pixel information differences exceeds the proportional threshold.

In some embodiments of the present disclosure, image comparison can also involve comparing the hash values of the blocks. The difference threshold in this case can be defined as a hash difference threshold. The electronic device can calculate the difference between the hash value of each block in the to-be-processed image and the corresponding block in the processed image. If the difference exceeds the hash difference threshold, the block can be determined as a first block.

It is understandable that, the electronic device can compare the differences between the to-be-processed image and the processed image on a block-by-block procedure, and then process only the blocks where the image difference exceeds the difference threshold, by the image processing model. This approach enhances the accuracy of determining the first blocks.

In some embodiments of the present disclosure, the electronic device may include a comparator, configured to compare the image differences between two blocks. This hardware structure is simple and easy to be implemented.

In some embodiments of the present disclosure, the electronic device can compile multiple processing codes corresponding to multiple blocks individually, to generate multiple processing instructions. The image processing model processes the multiple blocks in the to-be-processed image, by running the multiple processing instructions.

In the embodiments of the present disclosure, each processing code corresponds to one block. During the offline compilation phase, the electronic device is able to compile multiple processing codes used for processing different blocks individually, to generate multiple processing instructions. The image processing model can process different blocks, by running different processing instructions,

It should be noted that, when processing pixels in an image, the image processing model usually uses pixels located nearby, and rarely uses pixels located farther away. Thus, when the image processing model performs inference on each block, it can prevent the influence by other blocks. Multiple processing instructions can run independently to process the corresponding blocks, wherein each block serves as the processing unit for the image processing model.

In some embodiments of the present disclosure, when there are multiple types of inference modules included in the image processing model, the image processing model can independently process different blocks. This allows different types of inference to be performed on different blocks. For example, block 1 of the to-be-processed image can be used for image recognition, block 2 can be used for image segmentation, or other operations such as de-noising or super-resolution. In this case, the inference for different blocks can be configured based on actual needs, which is able to enhance the flexibility of the image processing model in performing inference on the image.

In some embodiments of the present disclosure, the image processing model includes multiple sub-models. At S101, the process, which is inputting the first blocks from the multiple divided blocks of the to-be-processed image, into the image processing model, and then obtaining the block processing results for the first blocks, further include: and processing the first blocks, by running the first processing instructions, to obtain the block processing results of the first blocks, and processing the first blocks, by running the first processing instructions, to obtain the block processing results of the first blocks.

In the embodiments of the present disclosure, each processing instruction corresponds to a sub-model. Running the multiple processing instructions corresponding to the multiple blocks, is to execute the image processing model, which includes the multiple sub-models. In this case, the electronic device can run the first processing instructions corresponding to the first blocks, to process the first blocks through the sub-model associated with the first processing instructions, in order to obtain the processing results of the first blocks.

For example, the to-be-processed image consists of 6 blocks, and the image processing model may include 6 sub-models. In his case, each sub-model can be used to process a block. The first blocks include block 4 and block 5. The electronic device can run the processing instruction corresponding to block 4, to process block 4 through the sub-model associated with block 4, and obtain the processing result of block 4. Similarly, it can run the processing instruction corresponding to block 5, to process block 5 through the sub-model associated with block 5, and obtain the processing result of block 5. These results in the above processing outcome the results of the first blocks.

It is understandable that, when processing the first blocks, the electronic device can only run the processing instructions corresponding to the first blocks. By only executing these necessary instructions to process the first blocks through the sub-models, the number of processing instructions is reduced, which reduces computational power consumption.

In some embodiments of the present disclosure, the multiple blocks can have the same size, and the image processing model includes one sub-model. The first blocks comprise at least one block. The electronic device can run one of the processing instructions, and process the at least one block of the first blocks, through the sub-model at least once, to obtain the processing results of the first blocks.

In the embodiments of the present disclosure, the to-be-processed image can be divided into multiple blocks with a same size, and the image processing model includes only one sub-model. In this case, the sub-model runs multiple times, to process each block once at a time. There is only one compiled processing instruction in the electronic device. The device can run the processing instruction, to process the blocks through the sub-model, with the times equal to the number of blocks in the first blocks. This achieves the processing of the first blocks and obtains the processing results of the first blocks.

For example, the to-be-processed image consists of 6 blocks, and the image processing model may include one sub-model to process each block. The first blocks include block 4 and block 5. The electronic device can run the processing instruction corresponding to the sub-model, and run the sub-model twice, once to process block 4 and once to process block 5. This achieves the processing results of block 4 and block 5, and obtains the processing results of the first blocks.

It is understandable that when the multiple blocks of the to-be-processed image are evenly divided, the electronic device can compile a single processing code to generate one processing instruction. Subsequently, the corresponding sub-model can process one block at a time, by running this single processing instruction This approach reduces the compilation workload, and allows the image processing model to retain only one sub-model, which minimizes the resources occupied by the image processing model.

In some embodiments of the present disclosure, the block processing results of multiple blocks from the processed image are stored in a predefined cache. The splicing process includes: obtaining the processing results of the second blocks of the processed image from the predefined cache, and splicing them with the block processing results of the first blocks of the to-be-processed image, to obtain the image processing result of the to-be-processed image.

In the embodiments of the present disclosure, the electronic device can store the image processing results of the processed image in a predefined cache. These image processing results include the block processing results of multiple blocks. The location of the predefined cache can be configured as needed, and shall not be limited in the embodiments of the present disclosure. In some embodiments, the predefined cache can be implemented as Double Data Rate (DDR) synchronous dynamic random-access memory, or On-Chip Memory (OCM), which can simplify the hardware design.

In the embodiment of the present disclosure, after obtaining the block processing results of the first blocks of the to-be-processed image, the electronic device can obtain the block processing results of the second blocks of the processed image from the predefined, and splice the two results, to obtain the image processing result of the to-be-processed image.

In some embodiments of the present disclosure, the electronic device can also replace the block processing results of the first blocks of the processed image in the predefined cache with the block processing results of the first blocks of the to-be-processed image. In this way, the predefined cache will store the image processing results of the to-be-processed image.

It is understandable that, by storing the image processing results of the processed image in the predefined cache, the electronic device can quickly complete the splicing process, which can improve the efficiency of obtaining the image processing results for the to-be-processed image.

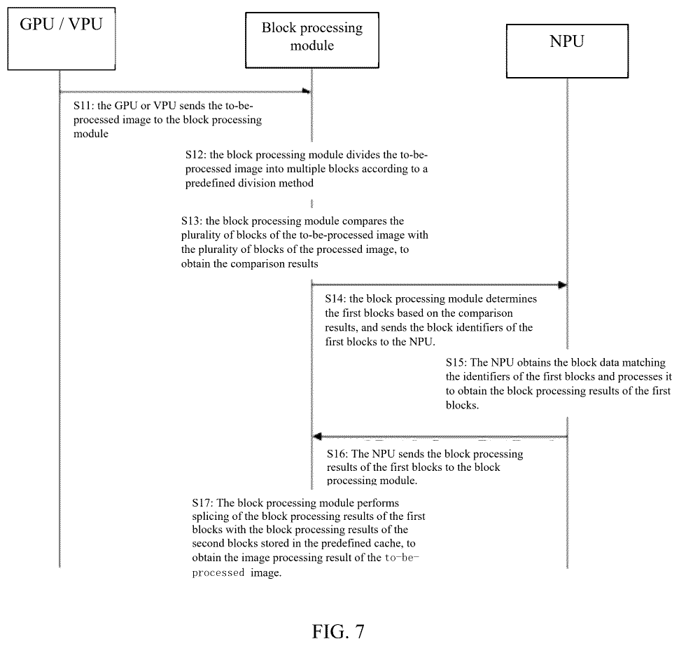

Based on the aforementioned data processing method, the present disclosure provides an interaction flow for data processing. As shown in FIG. 7, the interaction flow may include steps from S11 to S17.

At S11, the graphics processing unit (GPU) or video processing unit (VPU) transmits the to-be-processed image to the block processing module.

In S11, the Graphics Processing Unit (GPU) can send the to-be-processed image to the block processing module. Alternatively, the Video Processing Unit (VPU) can treat the frames requiring processing in a video file as to-be-processed images and send them to the block processing module. In this case the block processing module can be a module within the Central Processing Unit (CPU), or a custom hardware module outside the CPU. The specific configuration can be determined based on practical requirements.

At S12, the block processing module divides the to-be-processed image into multiple blocks according to a predefined division approach.

At S13, the block processing module compares the multiple blocks of the to-be-processed image with the multiple blocks of the processed image, to obtain the comparison results.

At S14, the block processing module determines the first blocks based on the comparison results, and sends the block identifiers of the first blocks to the Neural Network Processing Unit (NPU).

In S12-S14, the block processing module is responsible for dividing the to-be-processed image and identifying the first blocks in the divided image. The Neural Network Processing Unit (NPU) is typically an embedded neural network processor. By executing the processing instructions obtained through compilation, the NPU enables the operation of the image processor.

At S15, the Neural Network Processing Unit (NPU) obtains the block data matching the identifiers of the first blocks and processes it to obtain the block processing results of the first blocks.

In S15, the NPU executes the processing instructions corresponding to the first blocks, running the first sub-model in the image processing model to process the first blocks and obtain their block processing results.

At S16, the Neural Network Processing Unit (NPU) sends the block processing results of the first blocks to the block processing module.

In S16, after the NPU obtains the block processing results of the first blocks, it sends these results to the block processing module for splicing.

At S17, the block processing module performs splicing of the block processing results of the first blocks with the block processing results of the second blocks stored in the predefined cache, to obtain the image processing result of the to-be-processed image.

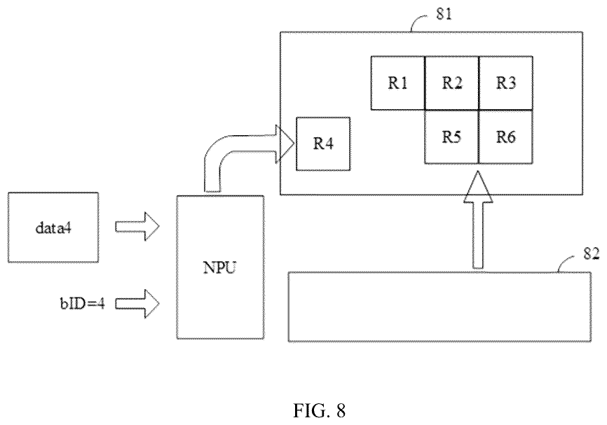

As illustrated in FIG. 8, during the implementation of steps S15 and S16, the NPU retrieves the block identifier bID of the first block, identified as block 4. The NPU then obtains the data for block 4 (data4) and processes it to produce the block processing result for block 4 (R4). Subsequently, block processing module 81 retrieves the block processing results of blocks 1-3 (R1-R3) and blocks 5-6 (R5-R6) from the predefined cache 82. These results are spliced with the block processing result of block 4 (R4) to generate the image processing result for the to-be-processed image.

It is understandable that, the block processing module can divide the to-be-processed image into multiple blocks and identify the first blocks out of them. In this case, the NPU then processes the first blocks to obtain the block processing results. The block processing module subsequently performs splicing of the block processing results of the first blocks with the block processing results of the second blocks from the processed image, to generate the image processing result for the to-be-processed image. By introducing the block processing module, the computational load on the NPU can be reduced, which saves computational resources.

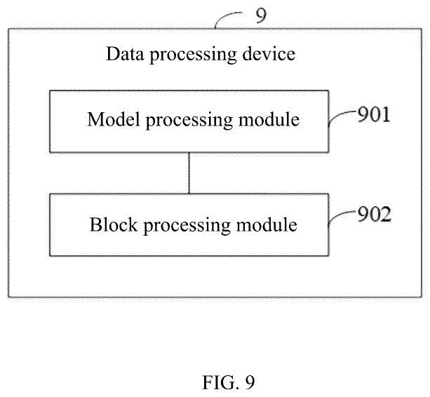

Based on the above data processing method, the present disclosure provides a data processing device, as shown in FIG. 9. More specifically, the data processing device 9 may include:

A model processing module 901, configured to input the first blocks among the multiple divided blocks of the to-be-processed image into the image processing model, to obtain the block processing results of the first blocks. The first blocks are the blocks of the to-be-processed image that satisfy the processing condition compared to the processed image. A same division approach shall be applied on the processed image and the to-be-processed image.

A block processing module 902, configured to combine the block processing results of the first blocks with the block processing results of the second blocks from the processed image, to generate the image processing result of the to-be-processed image. The second blocks are the blocks of the to-be-processed image, which do not meet the processing condition, compared to the processed image.

In some embodiments of the present disclosure, the block processing module 902 is further configured to compare each block of the to-be-processed image with the corresponding block in the processed image one by one, to obtain comparison results. When the comparison results indicate that the image difference between at least one block in the to-be-processed image and the corresponding block in the processed image is greater than a difference threshold, the module determines that the at least one block satisfies the processing condition.

In some embodiments of the present disclosure, the data processing device 9 further includes a compilation module. The compilation module is configured to compile multiple processing codes corresponding the multiple blocks individually, to generate multiple processing instructions. The image processing model processes the multiple blocks in the to-be-processed image, by running the multiple processing instructions.

In some embodiments of the present disclosure, the image processing model includes multiple sub-models. The model processing module 901 is further configured to run first processing instructions of the multiple processing instructions corresponding to the first blocks, and to process the first blocks, by running the first processing instructions, to obtain the block processing results of the first blocks.

In some embodiments of the present disclosure, the multiple blocks have the same size, and the image processing model includes one sub-model. The first blocks comprise at least one block. The model processing module 901 is further configured to run one of the processing instructions, and process the least one block of the first blocks, through the sub-model at least once, to obtain the processing results of the first blocks.

In some embodiments of the present disclosure, the block processing module 902 is further configured to obtain the processing results of the second blocks of the processed image from the predefined cache and splice with the block processing results of the first blocks of the to-be-processed image to generate the image processing result of the to-be-processed image. Additionally, the module replaces the block processing results of the first blocks of the processed image in the predefined cache with the block processing results of the first blocks of the to-be-processed image.

In some embodiments of the present disclosure, the to-be-processed image and the processed image are consecutive video frames. The number of blocks is positively correlated with the resolution of the consecutive frames, and/or negatively correlated with the image change rate between the consecutive frames.

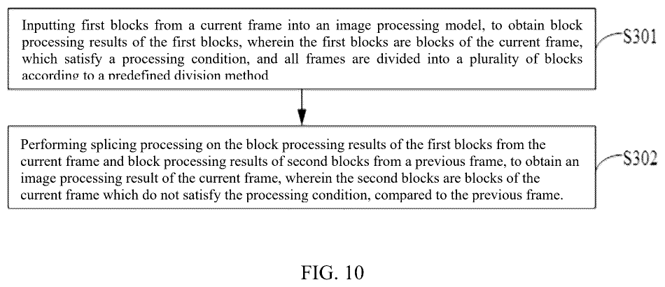

Based on the above data processing method, the present disclosure provides a video processing method. as shown in FIG. 10, the video processing method includes step S301 and S302.

At S301, inputting the first blocks of a current frame into an image processing model, to obtain block processing results of the first blocks. The first blocks are the blocks of the current frame that satisfy a processing condition, compared to the previous frame. All frames are divided into multiple blocks according to a predefined division approach.

At S302, performing splicing of the block processing results of the first blocks from the current frame with the block processing results of second blocks from the previous frame, to obtain the image processing result of the current frame. The second blocks are the blocks of the current frame which do not satisfy the processing condition, compared to the previous frame.

In the embodiments of the present disclosure, the electronic device can sequentially process consecutive frames using the image processing model to obtain the processing results for each frame. The current frame is the frame that the image processing model is about to process, while the previous frame is the frame that the image processing model has just processed. Each frame is required to be divided into multiple blocks according to the predefined division approach. In this case, the electronic device can compare each block of the current frame with the corresponding block of the previous frame to determine the first blocks, which satisfy the processing condition. The first blocks are input into the image processing model to obtain the corresponding block processing results. These results are then spliced with the block processing results of the second blocks from the previous frame, which do not meet the processing condition, to generate the image processing result for the current frame.

It should be noted that, when the to-be-processed image and the processed image are the consecutive video frames, the data processing method is just the video processing method described in the embodiments of the present disclosure. In this case, the to-be-processed image is the current frame, and the processed image is the previous frame. Based on this, any method described in the data processing method can be used in the video processing method the present disclosure. There is no need to repeat the content at this point.

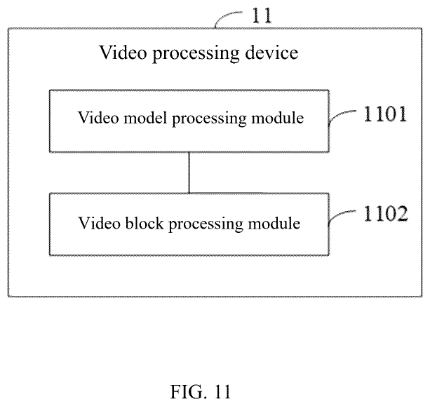

Based on the above video processing method, the present disclosure further provides a video processing device. As shown in FIG. 11, the video processing device 11 include:

A video model processing module 1101, configured to input first blocks from multiple blocks of a divided to-be-processed image into an image processing model, to obtain block processing results of the first blocks. The first blocks are the blocks of the to-be-processed image, which satisfy a processing condition, compared to a processed image. The processed image and the to-be-processed image are divided in the same approach.

A video block processing module 1102, configured to perform splicing of the block processing results of the first blocks with the block processing results of second blocks from a previous frame, to obtain image processing result of the current frame. The second blocks are the blocks of the current frame which do not satisfy the processing condition, compared to the previous frame.

In some embodiments of the present disclosure, the video block processing module 1102 is further configured to compare each block of the to-be-processed image with the corresponding block in the processed image one by one to obtain comparison results. When the comparison results indicate that at least one block in the to-be-processed image comparing the corresponding block in the processed image, has the difference greater than a threshold, the module determines that the at least one block satisfies the processing condition.

In some embodiments of the present disclosure, the video processing device 11 further includes a model compilation module. The model compilation module is configured to compile multiple processing codes corresponding to the multiple blocks individually, to generate multiple processing instructions. The image processing model processes the multiple blocks in the to-be-processed image, by running the multiple processing instructions.

In some embodiments of the present disclosure, the image processing model includes multiple sub-models. The video model processing module 1101 is further configured to run first processing instructions corresponding to the first blocks from the multiple processing instructions, and to process the first blocks, by running the first processing instructions, to obtain the block processing results of the first blocks.

In some embodiments of the present disclosure, the multiple blocks have the same size, and the image processing model includes one sub-model. The first blocks comprise at least one block. The video model processing module 1101 is further configured to run one of the processing instructions, and process the least one block of the first blocks, through the sub-model at least once, to obtain the processing results of the first blocks.

In some embodiments of the present disclosure, the video block processing module 1102 is further configured to obtain the processing results of the second blocks of the processed image from the predefined cache, and splice with the block processing results of the first blocks of the to-be-processed image, to generate the image processing result of the to-be-processed image. Additionally, the module replaces the block processing results of the first blocks of the processed image in the predefined cache with the block processing results of the first blocks of the to-be-processed image.

In some embodiments of the present disclosure, the to-be-processed image and the processed image are consecutive video frames. The number of blocks is positively correlated with the resolution of the consecutive frames, and/or negatively correlated with the image change rate between the consecutive frames.

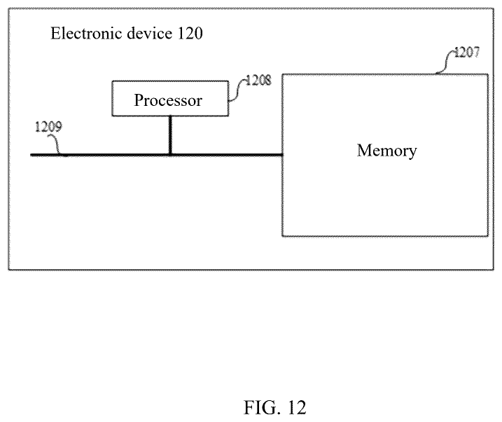

The present disclosure further provides an electronic device. As shown in FIG. 12, the electronic device 120 includes a memory 1207, a processor 1208, and a computer program stored in the memory 1207 and executable on the processor 1208. The processor 1208, when running the computer program, executes the data processing method or video processing method as described in the aforementioned embodiments.

It is understandable that the electronic device 120 also includes a bus system 1209. The multiple components within the electronic device 120 are coupled together via the bus system 1209. The bus system 1209 facilitates connection and communication among the multiple components. In addition to the data bus, the bus system 1209 includes a power bus, a control bus, and a status signal bus.

It is understandable that the memory in the embodiments of the present disclosure can be volatile memory, non-volatile memory, or a combination of both. Non-volatile memory can include Read-Only Memory (ROM), Programmable Read-Only Memory (PROM), Erasable Programmable Read-Only Memory (EPROM), Electrically Erasable Programmable Read-Only Memory (EEPROM), Ferromagnetic Random Access Memory (FRAM), Flash Memory, magnetic surface memory, optical discs, or Compact Disc Read-Only Memory (CD-ROM). Magnetic surface memory may refer to magnetic disk storage or magnetic tape storage. Volatile memory can include Random Access Memory (RAM), which serves as external high-speed cache. By way of example but not limitation, various types of RAM can be used, such as Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), or Direct Rambus Random Access Memory (DRRAM). The memory described in the embodiments of the present disclosure is intended to include, but is not limited to, these and any other suitable types of memory.

The methods disclosed in the embodiments of the present disclosure can be applied to or implemented by a processor. The processor may be an integrated circuit chip with signal processing capabilities. During implementation, each step of the above methods can be completed through integrated logic circuits in the processor's hardware or as software-based instructions. The processor can be a general-purpose processor, a DSP (Digital Signal Processor), or other programmable logic devices, discrete gate or transistor logic devices, or discrete hardware components. The processor can implement or execute the methods, steps, and logic flow diagrams disclosed in the embodiments of the present disclosure. A general-purpose processor may include a microprocessor or any conventional processor. The steps of the methods disclosed in the embodiments of the present disclosure can be directly executed by hardware within the processor or through a combination of hardware and software modules within the processor. The software modules can be stored in a storage medium located in memory. The processor reads information from the memory and completes the steps of the methods in combination with its hardware.

The embodiments of the present disclosure provide a computer-readable storage medium storing a computer program, which, when executed by a processor, implements the steps of the data processing method or video processing method described above.

In the embodiments provided by the present disclosure, it should be understood that the disclosed devices and methods can be implemented in other ways. The described embodiments of the devices are merely illustrative. For example, the division of modules is merely a logical functional division, and in actual implementation, there may be other division approaches, such as multiple modules or components being combined or integrated into another system, some features being omitted, or not executed. Additionally, the coupling, direct coupling, or communication connections between the components shown or discussed can be through certain interfaces, indirect coupling, or communication connections via devices or modules, which may be electrical, mechanical, or in other forms.

The above description is merely exemplary of the embodiments of the present disclosure and is not intended to limit the scope of protection of the present disclosure. Any modifications, equivalent substitutions, or improvements made within the spirit and scope of the present disclosure are included within the scope of protection of the present disclosure.

What is claimed is:

1. A data processing method comprising:
inputting first blocks from a plurality of blocks of a divided to-be-processed image into an image processing model, to obtain block processing results of the first blocks, wherein the first blocks are blocks of the to-be-processed image, which satisfy a processing condition, and the processed image and the to-be-processed image are divided in a same division method; and
performing splicing processing on the block processing results of the first blocks and block processing results of second blocks of the processed image, to obtain an image processing result of the to-be-processed image, wherein the second blocks are blocks of the to-be-processed image which do not satisfy the processing condition, compared to the processed image.

2. The method according to claim 1, further comprising:
comparing each block of the to-be-processed image with a corresponding processed block of the processed image one by one to obtain comparison results; and
determining that at least one block satisfies the processing condition in response to the comparison results indicating that an image difference between the unprocessed block and the corresponding processed block is greater than a difference threshold.

3. The method according to claim 1, further comprising:
compiling a plurality of processing codes in a one-to-one correspondence to the plurality of blocks, respectively, to generate a plurality of processing instructions; and
processing the plurality of blocks of the to-be-processed image through the image processing model, by calling the plurality of processing instructions.

4. The method according to claim 3, wherein the image processing model includes a plurality of sub-models, and inputting the first blocks of the plurality of blocks of the divided to-be-processed image into the image processing model to obtain the block processing results of the first blocks includes:
calling the first processing instructions corresponding to the first blocks from the plurality of processing instructions, and processing the first blocks by calling the corresponding sub-models through the first processing instructions to obtain the block processing results of the first blocks.

5. The method according to claim 3,
wherein the plurality of blocks have the same size; the image processing model includes a sub-model; and the first blocks includes at least one block,
the method further comprising:
calling one first processing instruction of the first processing instructions, and processing the at least one first block of the first blocks by running the sub-model at least once to obtain the block processing results of the first blocks.

6. The method according to claim 1, wherein the block processing results of the plurality of blocks of the processed image are stored in a predefined cache; and the splicing processing includes:
obtaining the processing results of the second blocks of the processed image from the predefined cache, and splicing the processing results of the second blocks with the block processing results of the first blocks of the to-be-processed image to obtain the image processing result of the to-be-processed image;
replacing the block processing results of the first blocks of the processed image in the predefined cache with the block processing results of the first blocks of the to-be-processed image.

7. The method according to claim 1, wherein:
the to-be-processed image and the processed image are consecutive video frames;
a number of the plurality of blocks is positively correlated with resolutions of the consecutive frames; and/or
the number of plurality of blocks is negatively correlated with an image change rate between the consecutive frames.

8. A data processing device, comprising:
a model processing module, configured to input first blocks from a plurality of blocks of a divided to-be-processed image into an image processing model, to obtain block processing results of the first blocks, wherein the first blocks are the blocks of the to-be-processed image, which satisfy a processing condition, and processed image and the to-be-processed image are divided in a same division method; and
a block processing module, configured to perform splicing processing on the block processing results of the first blocks and block processing results of second blocks of the processed image, to obtain an image processing result of the to-be-processed image, wherein second blocks are blocks of the to-be-processed image which do not satisfy the processing condition, compared to the processed image.

9. The data processing device according to claim 8, wherein the block processing module is further configured to:
compare each block of the to-be-processed image with a corresponding processed block of the processed image one by one to obtain comparison results; and
determine that at least one block satisfies the processing condition in response to the comparison results indicating that an image difference between the unprocessed block and the corresponding processed block is greater than a difference threshold.

10. The data processing device according to claim 8, further comprising a compilation module configured to:
compile a plurality of processing codes in a one-to-one correspondence to the plurality of blocks, respectively, to generate a plurality of processing instructions; and
process the plurality of blocks of the to-be-processed image through the image processing model, by calling the plurality of processing instructions.

11. The data processing device according to claim 10, wherein the image processing model includes a plurality of sub-models, and the block processing module is further configured to:
call the first processing instructions corresponding to the first blocks from the plurality of processing instructions, and process the first blocks by calling the corresponding sub-models through the first processing instructions to obtain the block processing results of the first blocks.

12. The data processing device according to claim 11, wherein the plurality of blocks are of the same size; the image processing model includes a sub-model; and the first blocks includes at least one block; and the image processing module is further configured to:
call one first processing instruction of the first processing instructions, and process the at least one first block of the first blocks by running the sub-model at least once to obtain the block processing results of the first blocks.

13. The data processing device according to claim 8, wherein the block processing results of the plurality of blocks of the processed image are stored in a predefined cache; and the block processing module is further configured to:
obtain the processing results of the second blocks of the processed image from the predefined cache, and splice the processing results of the second blocks with the block processing results of the first blocks of the to-be-processed image to obtain the image processing result of the to-be-processed image; and
replace the block processing results of the first blocks of the processed image in the predefined cache with the block processing results of the first blocks of the to-be-processed image.

14. The data processing device according to claim 8, wherein:
the to-be-processed image and the processed image are consecutive video frames;
a number of the plurality of blocks is positively correlated with resolutions of the consecutive frames; and/or
the number of plurality of blocks is negatively correlated with an image change rate between the consecutive frames.

15. A video processing method, comprising:
inputting first blocks from a current frame into an image processing model, to obtain block processing results of the first blocks, wherein the first blocks are blocks of the current frame, which satisfy a processing condition, and all frames are divided into a plurality of blocks according to a predefined division method; and
performing splicing processing on the block processing results of the first blocks from the current frame and block processing results of second blocks from a previous frame, to obtain an image processing result of the current frame, wherein the second blocks are blocks of the current frame which do not satisfy the processing condition, compared to the previous frame.
